(19) United States
(12) Patent Application Publication
(10) Pub. No.: US 2005/0289538 A1
(43) Pub. Date: Dec. 29, 2005

(54) Deploying an application software on a virtual deployment target

(75) Inventors: Elizabeth Ann Black-Ziegelbein, Austin, TX (US); Thomas R. Gissel, Cary, NC (US); Brian Keith Martin, Cary, NC (US); Leigh Allen Williamson, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/874,493

(22) Filed: Jun. 23, 2004

(51) Int. Cl. G06F 9/45

(52) U.S. Cl. 717/177

(57) ABSTRACT

Methods and arrangements to propagate application software to a virtual deployment target are contemplated. More specifically, a user may create multiple virtual deployment targets in a software system such as WebSphere™ and deploy applications to multiple the virtual deployment targets without having to manually fit policy-driven applications into each virtual deployment target. Embodiments are particularly advantageous when the application software is a business solution that needs to be deployed multiple times such as during the development and testing of the business solution. For example, application software of a business solution typically includes a group of applications designed to cooperatively function as a single entity. An application bundle such as an Enterprise Application Solution (EAS) file describes the application software and includes pertinent information about the application software, application configuration data, and runtime configuration data to implement the business solution. Then, the application bundle can be deployed automatically or substantially automatically.

### FIELD OF INVENTION

The present invention is in the field of computer software. More particularly, the present invention relates to methods and arrangements to deploy an application software including more than one applications on to a virtual deployment target such as a virtual testing environment for Java™ 2 Platform, Enterprise Edition (J2EE) applications.

### BACKGROUND

The development and deployment of business application software is a complex project. Software developers not only have to design, develop, and test the software but also spend considerable effort in configuring various testing environments for installation and execution of the software. One application environment, Java™ 2 Platform, Enterprise Edition (J2EE), simplifies software development and reduces programmer training by including standardized, reusable modular components. The J2EE platform is a platform-independent, Java-centric environment from Sun for developing, building and deploying Web-based enterprise applications online. The J2EE platform consists of a set of services, APIs, and protocols that provide the functionality for developing multi-tiered, Web-based applications. For instance, at the client tier, the J2EE platform supports pure HTML, as well as Java™ applets or applications. The J2EE platform relies on Java™ Server Pages and servlet code to create HTML or other formatted data for the client. Enterprise JavaBeans (EJBs) provide a layer of logic for the platform. An EJB server provides functions such as threading, concurrency, security and memory management, all of which are typically transparent to the user. Java™ Database Connectivity (JDBC), which is the Java™ equivalent to Open Database Connectivity (ODBC), is the standard interface for Java™ databases. And, the Java™ servlet application program interface (API) provides a consistent interface for users without requiring a graphical user interface (GUI).

Although J2EE simplifies development of the software, users typically spend a great deal of time on deployment issues, especially deployment issues related to virtual deployment targets. Deployment of J2EE applications involves configuring the system environment and support resources of a target server, and installing the application into that system environment. The J2EE platform software applications often need to be moved between multiple environments to facilitate different stages of testing before the applications are ready for use via, e.g., an intranet or the Internet. In particular, software developers often move J2EE applications between various testing environments such as development, integration test, system test, load and stress test, and user acceptance test environments before deploying the applications into production environments.

Each deployment of the application typically involves configuration of the environment, which greatly slows down installation. More specifically, configuration of each system environment includes actions to link the software application to resources necessary for testing and execution. For example, an administrator may need to setup one or more EJB servers, databases, etc. Then, the administrator may configure links between parts of the application, and links with the servers, databases, libraries, applications, and/or other resources.

One problem is that customers manually configure environments and the application for installation. Manually configuring and deploying an assembled J2EE application is complicated, requiring a customer to have an extensive knowledge in the use of J2EE, especially for situations in which an application requires a server that is not an existing, default server. The exhaustive list of runtime settings, for instance, commonly includes choices such as whether to automatically load servlets or to pre-compile Java™ Server Page (JSP) files. These settings are comprehensive, detailed, and easy to blunder. Examples of some of the tasks that system administrators may perform are initializing server data, software properties, descriptions of resources, descriptions of the virtual deployment target, description of the deployment host, information for a cluster and specific node group in the virtual deployment target, and the like. Some system administrators manually perform these tasks. Many system administrators do not have sufficient J2EE knowledge and the experience necessary to perform system maintenance requirements.

Another problem relates to the time to migrate between environments. The time to migrate between environments is so significant that project schedules are often delayed and customers tend to take short cuts in testing applications, risking even greater delays. For instance, a customer may deploy an application more than twenty times during a project. As a result, the customer frequently combines several test environments into one test environment to expedite completion of the project. The customer may combine, e.g., a build test environment and a pre-production test environment into a cursory, preliminary test, increasing the probability that a costly error will elude early detection.

Currently, customers and vendors try to reduce installation time by including data to describe environment configurations in archive files with the applications. In particular, customers or vendors compress application binaries, or files, with deployment descriptors into an Enterprise Archive (EAR) file and provide scripts via, e.g., Windows NT® or UNIX® scripted tools, to extract configuration data from the deployment descriptors to transfer the application to another environment. An EAR file contains an entire J2EE application including its components along with the deployment descriptors. Deployment descriptors may include, for instance, Extensible Markup Language (XML) files to provide meta information about the application and individual modules. Advantageously, XML files use common information formats so that data in a format described by the XML file can be interpreted by numerous platforms.

Typical modules within the EAR file include Enterprise JavaBeans (EJB), Web Archive (WAR) files, and Resource Adapter Archive (RAR) files. An EJB is a Java™ application program interface that defines component architecture for multi-tier client/server systems. The goal of EJB system is to allow developers to focus on the business architecture of a model, rather than the endless amounts of programming and coding needed to connect all the working parts. This task is left to EJB server vendors. Developers design or purchase EJB components and arrange them on a server.

A WAR file is a compressed file including servlets, JSPs and other resources to allow control of specific resources' behavior within an application server. And a RAR file includes a compression program format designed for compressing large files.

Unfortunately, the use of scripts to interpret data recovered via the deployment descriptors is very time-consuming at the front-end, requires extensive knowledge of the J2EE platform, and is high maintenance, often leading to errors. In addition, deployment of the application from one environment to the next is typically part of an administrator's responsibility and the administrator normally does not have the extensive knowledge of the J2EE platform necessary to create and maintain the script files.

The current techniques, methodologies, and software tools available to software developers and system administrators are error prone, time-consuming, costly, and require extensive J2EE knowledge. Therefore, a need exists for methods and software to simplify the steps and user interaction required to deploy software to a virtual deployment target.

### SUMMARY OF THE INVENTION

The problems identified above are in large part addressed by methods and arrangements to deploy an application software on a deployment target. One embodiment provides a method to deploy an application software embodied by one or more applications on a deployment target. This method begins by receiving an application bundle. The application bundle includes the one or more applications, runtime configuration data, and mappings and the mappings are adapted to associate the runtime configuration data with the one or more applications. The method further involves determining the deployment target based upon the runtime configuration data; installing the deployment target on a deployment host based upon the runtime configuration data; and deploying the one or more applications onto the deployment target based upon the mappings.

An additional embodiment provides an apparatus to deploy an application software embodied by one or more applications on a deployment target. The apparatus includes an interspection module to receive an application bundle, the application bundle having one or more applications, runtime configuration data, and mappings; to create the deployment target based upon the runtime configuration data; and to install the deployment target on a deployment host based upon the runtime configuration data. The apparatus also includes an exporter coupled with the interspection module to deploy the one or more applications onto the deployment target based upon the mappings.

A further embodiment provides a machine-accessible medium (medium) containing instructions, which when executed by a computer, cause the computer to perform operations, to deploy an application software embodied by one or more applications on a deployment target. The operations begin with receiving an application bundle. The application bundle includes the one or more applications, runtime configuration data, and mappings and the mappings are adapted to associate the runtime configuration data with the one or more applications. The operations further involves determining the deployment target based upon the runtime configuration data; installing the deployment target on a deployment host based upon the runtime configuration data; and deploying the one or more applications onto the deployment target based upon the mappings.

One embodiment provides an application bundle to deploy an application software embodied by one or more applications on a deployment target. Moreover, the application bundle may be designed to allow a user to configure the deployment target and install one or more applications together. The application bundle includes one or more application archive files for installation on a deployment target to implement the application software, the application archive files having one or more applications. The application bundle also includes one or more application runtime bundles having runtime configuration data and mappings to deploy the application software onto the deployment target. The runtime configuration data describes runtime behavior of the one or more applications to describe the deployment target based upon the mappings. The mappings associate the runtime bundles with the one or more application archive files.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an embodiment of a system to automatically create, compress, and use a file to configure a virtual deployment target and install an application within the virtual deployment target;

FIG. 2 depicts a block diagram of an embodiment of an application bundle including multiple archive files, a map, multiple application runtime bundles including server, policy, and resource information;

FIG. 3 depicts a block diagram of an embodiment of software modules to automatically deploy an application to a virtualized deployment target using an application bundle;

FIG. 4 depicts an embodiment of a computer system that may be a node upon which a deployment host and deployment target resides;

FIG. 5 depicts an example of a flowchart to create and export an application bundle with application software and application runtime configuration data;

FIG. 6 depicts an example of a flowchart to create and manage a map of an application archive to runtime configuration data in an application bundle;

FIG. 7 depicts an example of a flowchart to configure a deployment target based upon runtime configuration data in an application bundle; and

FIG. 8 depicts an example of a flowchart to import an application bundle into a virtual deployment target.

### DETAILED DESCRIPTION OF EMBODIMENTS

### Introduction

The following is a detailed description of embodiments of the invention depicted in the accompanying drawings. The embodiments are in such detail as to clearly communicate the invention. The amount of detail offered, however, is not intended to limit the anticipated variations of embodiments; but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Methods and arrangements to propagate application software to a virtual deployment target are contemplated. More specifically, a user may create multiple virtual deployment targets in a software system such as WebSphere™ and deploy applications to multiple the virtual deployment targets without having to manually fit policy-driven applications into each virtual deployment target. Embodiments are particularly advantageous when the application software is a business solution that needs to be deployed multiple times such as during the development and testing of the business solution. Embodiments facilitate installation of the application software. For example, application software of a business solution typically includes a group of applications designed to cooperatively function as a single entity such as an on-line inventory system to, e.g., improve data management and productivity of a business. An application bundle such as an Enterprise Application Solution (EAS) file describes the application software and includes pertinent information about the application software, application configuration data, and runtime configuration data to implement the business solution in any computer system having sufficient resources available for the business solution. Advantageously, the user(s), such as a software development team, may focus on the application software because the application software can be deployed automatically from the application bundle.

Further, application bundles do not necessary use a J2EE standard for a compressed file. In fact, application bundles may include multiple application archive files such as Enterprise Archive files (EARs) and multiple application runtime bundles such as Enterprise Archive Solution Module (EASM) files. The application archive files provide the application binaries for each application of the business solution and may optionally include application policies, which describe deterministic and/or non-deterministic configurations for the applications. The application runtime bundles describe runtime behavior of the applications such as the amount of memory necessary to execute the applications, whether the process can be shared with other applications, the number of instances that may execute simultaneously, etc.

The application runtime bundles also include mappings. Mappings associate each application runtime bundle with one or more application archive files. Wherever the application software may be copied, the data within the application archive files indicate, e.g., how to install the application binaries and the application runtime bundles describe links, or communication channels, between resources and the applications, such as libraries, databases, Java™ media frameworks (JMFs), etc.

### DETAILED DESCRIPTION

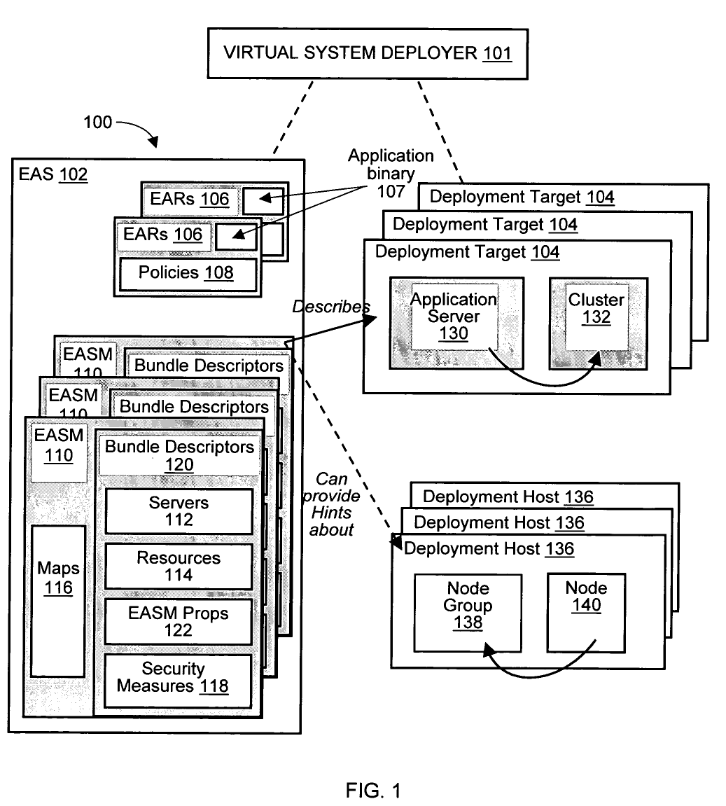

Turning now to the drawings, FIG. 1 depicts an embodiment of a system 100 to allow a user, for example, a Java™ 2 Platform Enterprise Edition (J2EE) administrator, to configure a virtual system and install application software in one operation. The application software may be a business solution including multiple applications that cooperatively function to provide a service for a customer. Further, the application software, in the present embodiment, is compressed into an archive file, EAS 102, for transmission into a computer system on which to deploy the application software.

In one embodiment, the virtual system is an environment for execution of the application software, which is adapted to provide an environment that is as close to optimal as possible given the available resources in system 100. In particular, deployment hosts 136 define the physical environment. Each deployment host 136 may be a node 140 such as a computer or a node group 138 such as a network of computers that has an operating system and a virtual system deployer 101 like WebSphere™.

Node groups 138 enable a user to divide a network into manageable units. A user may create node groups based on operating system, backup schedule, application type, or hardware type. In one embodiment, node groups 138 are groups of computers adapted to perform specific tasks or to interact with specific users.

Deployment hosts 136 may present, deploy, distribute, or make available an application installed on a deployment target 104 to the users. For example, applications typically have at least two deployment hosts: the workstation for the developer, and the computer on which the user executes the production application on a live Web site.

Each deployment target 104 includes an environment having links for at least the minimum number and types of hardware, firmware, and/or software resources to execute one or more of the applications represent by EARs 106. For example, deployment target 104 may be a set of communications channels to link an environment to libraries, databases, JMFs, and the like. Each deployment target 104 is associated with one or more deployment hosts 136 to associate the deployment target 104 with physical resources like memory, hard drives, compact disk drives, and the like. From the perspective of the application(s) deployed to the deployment target 104, the deployment target 104 may appear to be a computer system with an operating system, file structures, and hardware, firmware, and/or software resources.

Deployment targets 104 may include, e.g., an application server 130 or a cluster 132. Cluster 132 may be a grouping of like processes, for example, application servers or web servers.

EAS 102 is an application bundle including application archives, Enterprise Archive files (EARs) 106, and application runtime bundles, Enterprise Application Solution Modules (EASMs) 110. In one embodiment, the EAS 102 includes runtime definitions, which are descriptions of the runtime behavior of individual applications of EARs 106 and of the application software in general. Inclusion of the runtime definitions allows the application software to be self-contained and easily transferable, particularly when transferring the application software to environments that are not pre-configured for installation of the application software. More specifically, virtual system deployer 101 can interpret the contents of EAS 102 to select deployment hosts 136 for the application software and create deployment targets 104 on the deployment hosts 136. The application software can then be deployed on deployment targets 104. For example, virtual system deployer 101 may be part of a WebSphere™ Studio Application Developer™ system. WebSphere™ Studio Application Developer™ is a set of Java-based tools from IBM™ that allows customers to create and manage sophisticated business Web sites. The central WebSphere™ tool is the WebSphere™ Application Server (WAS), which is an application server that a customer can use to connect Web site users with the application software. Virtual system deployer 101 can create runtime deployment targets 104 and deploy the application software for the Web site users so the users can work with the application software simultaneously.

In one embodiment, EAS 102 is application-centric. When the EAS 102 is application-centric then the virtual system deployer 101 can quickly clone and deploy the application software to WebSphere™ Environments.

EARs 106 are ZIP files for individual applications, which, as a whole, make up the application software. EARs 106 that include application data, deployment descriptors, and configuration data. In many embodiments, EARs 106 may be included in EAS 102 as a separate ZIP file or decompressed and compressed with EASM 110. In some embodiments, virtual system deployer 101 creates EARs 106 via an application management application program interface (API) in the original deployment target. In other embodiments, the application management API locates EARs 106 in original deployment target and transmits EARs 106 via virtual system deployer 101 for inclusion in EAS 102. For example, virtual system deployer 101 may receive an instruction to move an application from original deployment target to deployment target 104. In response, virtual system deployer 101 may compress application data, application descriptors, and configuration data into EAR file 106 via application management API 107.

In one embodiment, Java™ 2 Platform Enterprise Edition (J2EE) applications bundle groups of files that perform a certain set of tasks into EARs 106. A developer writes different types of code, source objects application binary 107, creating Java™ Archive (JAR) files, Enterprise JavaBeans (EJB) files, WAR files, RAR files, and the like; each with a deployment descriptor which is an eXtensible Markup Language (XML) file. Enterprise JavaBeans (EJB) include a Java™ application program interface that defines component architecture for multi-tier client/server systems. In the present environment, applicable EJB components are internally designed or purchased and arranged on the computer. A WAR file, another type of application binary 107, is a compressed file that contains the Web Application resources of the J2EE application. Another type of application binary 107, a RAR file, is a compressed file that contains logic for connecting server environments to other legacy backend information systems such as Customer Information Control System (CICS) or Information Management System (IMS).

EARs 106 may optionally include policies 108. Policies 108 are application specific descriptions of deterministic and non-deterministic configurations for the applications in the corresponding EARs 106. Policies 108 may describe, for example, paths to components or servlets, indicate that the application should remain in memory, indicate that the application should always be persisted, and any other application specific configuration.

EAS 102 includes one or more EASMs 110 that function as application runtime bundles. EASM 110 includes bundle descriptors 120 to, e.g., describe deployment target 104 along with its associated servers 112, resources 114, properties 122, and security measures 118 for the applications contained within EARs 106. EASMs 110 also include maps 116 to associate one or more EARs 106 with EASMs 110. Servers 112 describe rules and policies associated with application server 130 and deployment host 136. EASM Properties 122 describe runtime behaviors of the applications of EARs 106 that are associated with the corresponding EASM 110 via maps 116. For example, EASM properties 122 may limit the number of instances of the applications executing simultaneously to one, require that at least five instances execute simultaneously to handle the minimum bandwidth, and other runtime behaviors. And, in some embodiments, server specific security measures 118 define authorized accesses for the application software, or a process executed on the deployment target(s) 104 associated with EASM 110.

As an illustration, a user may request that the application software represented by EAS 110 be deployed in the computer system represented by deployment hosts 136. Virtual system deployer 101 interprets bundle descriptors 120 to select deployment hosts 136. Further, based upon bundle descriptors 120, virtual system deployer 101 creates deployment targets 104 to generate a virtual target environment.

After the virtual system deployer 101 creates the virtual target environment, virtual system deployer 101 transmits EARs 102 to the deployment targets 104 indicated by maps 116 of each EASM 110 and deploys the applications from the EARs 106 in the corresponding deployment targets 104. Deployment of the applications typically involve configuration of the deployment targets 104 based upon configurations described in policies 108 for the corresponding EARs 106.

In further embodiments, virtual system deployer 101 may create EAS 102 based upon an installation in an existing environment. For example, virtual system deployer 101 may gather and compress individual applications in a deployment target either automatically or via user input. Virtual system deployer 101 may interact with a user or one or more application configuration files to determine deterministic and non-deterministic configurations to build EARs 106. Virtual system deployer 101 may also interact with a user or one or more runtime configuration files to determine runtime behaviors for applications including communication channels utilized by the applications to generate EASM 110. Then, virtual system deployer 101 may build EAS 102 by compressing EARS 106 and EASMs 110 into one or more archive files.

In one embodiment, virtual system deployer 101 may configure a deployment target 104 according to the configuration of another deployment target by copying the configuration to the deployment target 104. In a further embodiment virtual system deployer 101 may configure the deployment target 104 according to default application configurations and/or runtime configurations.

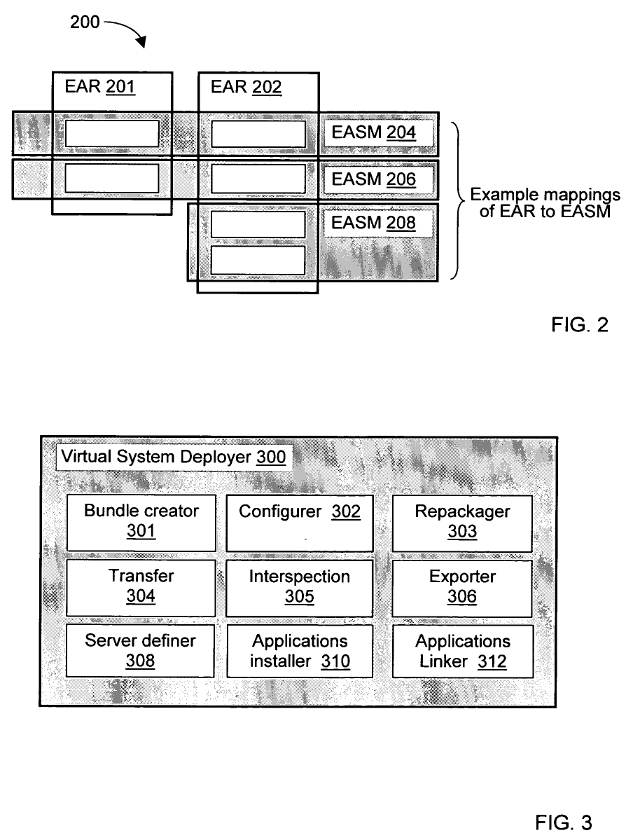

FIG. 2 depicting a visual embodiment of a map such as maps 116 for EASMs 110 of FIG. 1. In particular, a map of EASM 204 may associate EAR 201 and EAR 202 with the deployment target(s) associated with EASM 204 and EASM 206. Further, EASM 208 is associated with two instances of EAR 202 and no instances of EAR 201. Additional configuration data may include information to configure system surroundings in which application software may be installed and run. For instance, runtime configuration data associated with EAR 202 in EASM 208 may allow two instances of the application represent by EAR 202 to execute simultaneously. Alternatively, runtime configuration data of EASM 208 may allow each instance of the application represented by EAR 202 to be linked to two different users but only allow one user to execute functionality of the application at a time. For example, the applications represented by EAR 202 may facilitate modification of the same database resource. Runtime configuration data associated with EASM 208 and EAR 202 prevents both instances of the application from accessing the database resource at the same time.

FIG. 3 depicts a block diagram of an embodiment of a virtual system deployer 300 to automatically deploy an application software from an application bundle onto to a virtual deployment target. In many embodiments, virtual system deployer 300 includes logic such as software modules having instructions programmed for WebSphere XD™. The instructions are application-centric, and, thus, work independently and allow managed resources such as application software resources to interact directly with the management of virtual system deployer 300. Application-centric instructions, especially instructions of web services, enable the user to integrate applications and business processes without regard to a proprietary infrastructure, platform and operating system.

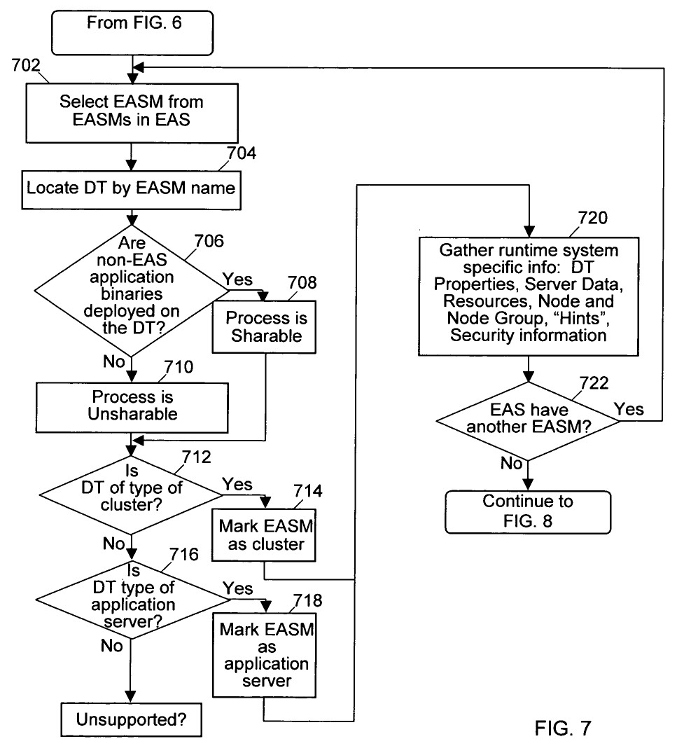

In the present embodiment, virtual system deployer 300 has logic including an application bundle creator component 301, configurer component 302, repackager component 303, dump component 304, decompress component 305, export component 306, import component 307, server definer component 308, node group definer component 309, applications installer 310, and applications linker component 312. The bundle creator component 301 creates an application archive file such as an EAR and application runtime bundles such as an EASM to provide runtime definitions, or configurations, to propagate the application software to the virtual deployment target. Bundle creator component 301 also creates maps between the application archive files and the application runtime bundles. Next, configurer component 302 configures the application runtime bundles that were created, as will be further discussed below in the description of FIG. 7.

Repackager component 303 packages both the application runtime bundles and the application archive files into the application bundle such as an EAS. The application bundle may include runtime configuration data, which may be a set of statements that define how network resources are allocated among clients, including security, password, and interface policy information. For example, the interface policy may allow access of a Common Object Request Broker Architecture (CORBA) service to certain choices that affect communication of objects of programs.

Transfer component 304 transfers the application bundle such as an EAS file to a file system location for deployment. At the file system location, interspection module 305 decompresses the application bundle to facilitate access to, e.g., EASM file and EAR files, and parses the runtime configuration data of an application runtime bundle to determine, e.g., servers, resources, and properties associated with the deployment target. Interspection module 305 creates a deployment target to match such characteristics of the deployment target as closely as possible given the available resources. In other embodiments, the deployment target may be selected from existing deployment targets.

Interspection module 305 then installs the deployment target onto a deployment host. More specifically, interspection module 305 compares the available deployment hosts against, e.g., the servers, resources, and properties of the deployment target such the number and types of links to resources and selects the best matching deployment host. For example, when a deployment target is associated substantially with Web services, interspection module 305 will select a deployment host that can satisfy the deterministic Web services links and most of the non-deterministic Web services links. Upon installing the deployment target on a deployment host, exporter 306 may read maps of EASM files to export EAR files to associated deployment targets.

Server definer 308 component locates or defines the server referenced in the application runtime bundle, assigns default and/or user-defined attributes to the server based upon the server data such as servers 112 of FIG. 1, and establishes associations based on runtime configurations described in the application bundle. Once the system determinations and definitions are made, applications installer component 310 initiates the installation of application archives files in the deployment target(s).

In a particular embodiment, applications linker component 312 links the application software to a virtual server, node group, and database via the virtual deployment target. In some other embodiments, server definer 308 reads the application runtime bundle to gather data to define a server on which to install the application software. The server data may be gathered, for instance, based upon a relationship with an existing server.

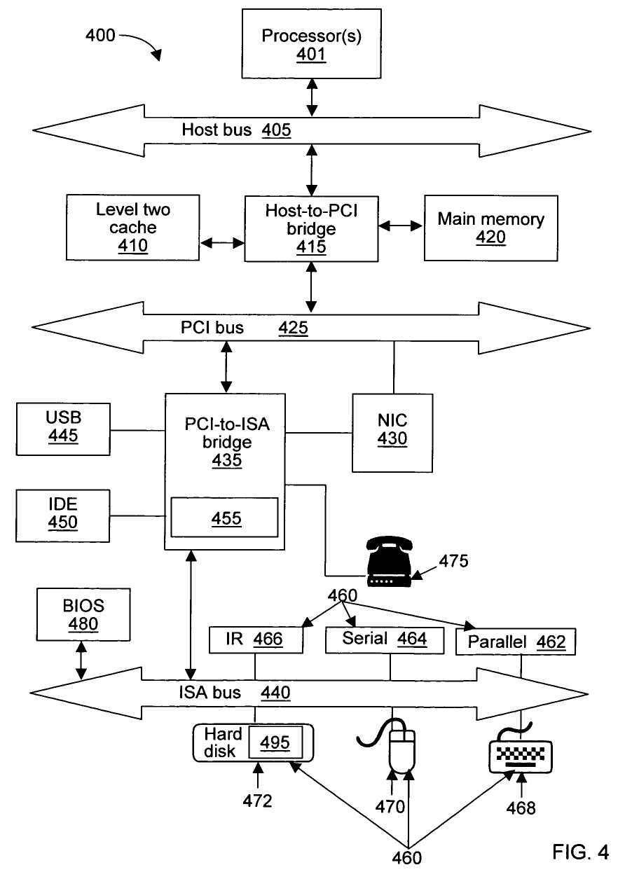

FIG. 4 depicts an embodiment of a computer system 400 that may be a node upon which a deployment host and deployment target resides. In further embodiments, computer system 400 may represent one node of multiple nodes involved with deployment of application software.

Computer system 400 includes processor 401, which is coupled to host bus 405. A level two (L2) cache memory 410 is also coupled to the host bus 405. Host-to-PCI bridge 415 is coupled to main memory 420, includes cache memory and main memory control functions, and provides bus control to handle transfers among PCI bus 425, processor 401, L2 cache 410, main memory 420, and host bus 405.

PCI bus 425 provides an interface for a variety of devices including, for example, a network interface card (NIC) 430 such as a LAN card. PCI-to-ISA bridge 435 provides bus control to handle transfers between PCI bus 425 and ISA bus 440, universal serial bus (USB) functionality 445, IDE device functionality 450, power management functionality 455, and can include other functional elements not shown, such as a real-time clock (RTC), DMA control, interrupt support, and system management bus support. Peripheral devices and input/output (I/O) devices can be attached to various interfaces 460 (e.g., parallel interface 462, serial interface 464, infrared (IR) interface 466, keyboard interface 468, mouse interface 470, fixed disk (HDD) 472) coupled to ISA bus 440. Alternatively, many I/O devices can be accommodated by a super I/O controller (not shown) attached to ISA bus 440.

In some embodiments, the virtual system deployer may transmit an EAR 495 to computer system 400 via NIC 430 and store EAR 495 in fixed disk 472. Then the virtual system deployer may decompress the EAR 495 to install an application from the EAR 495 in computer system 400.

Upon execution of the application from EAR 495, instructions extracted from EAR 495 may be loaded in main memory 420. As well, the virtual system deployer may obtain user input regarding the configuration values via the mouse 470, keyboard 468, or display 466. In a particular embodiment, computer system 400 is logically partitioned and, in further embodiments, computer system 400 is part of a grid of computers.

BIOS 480 is coupled to ISA bus 440, and incorporates the necessary processor executable code for a variety of low-level system functions and system boot functions. BIOS 480 can be stored in any computer readable medium, including magnetic storage media, optical storage media, flash memory, random access memory, read only memory, and communications media conveying signals encoding the instructions (e.g., signals from a network). In order to attach computer system 400 to another computer system to copy files over a network, NIC 430 is coupled to PCI bus 425 and to PCI-to-ISA bridge 435. Similarly, to connect computer system 400 to an ISP to connect to the Internet using a telephone line connection, modem 475 is connected to serial port 464 and PCI-to-ISA bridge 435.

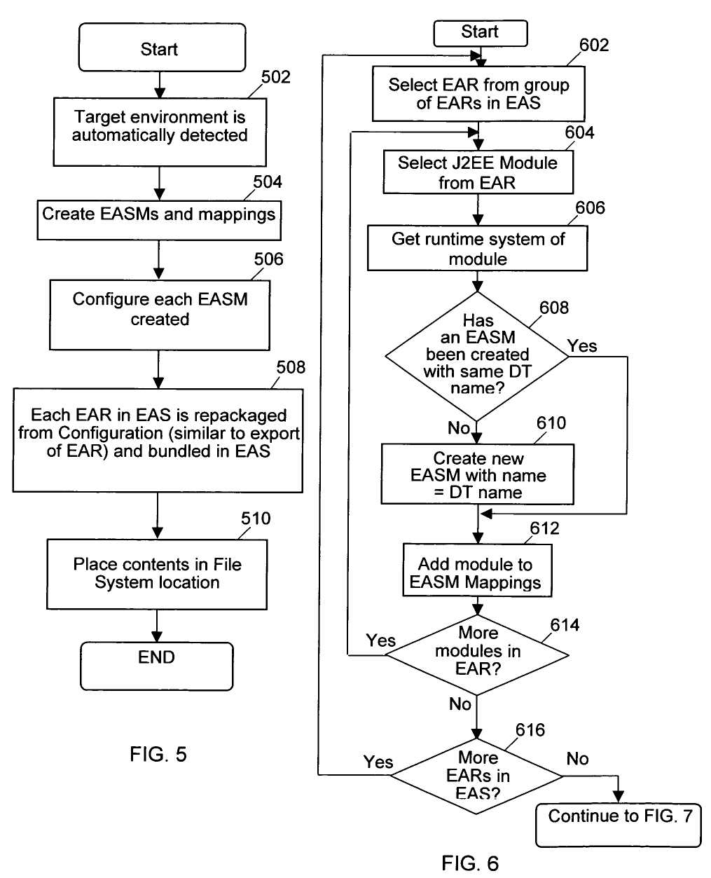

FIG. 5 depicts an example of a flowchart 500 to create and export an application bundle with application software and application runtime configuration data. In FIG. 5, the user selects the application software, e.g., an EAS, to export by entering the file name and location for export (element 502). The EAS includes the application archive files and application runtime bundles to support exportation.

The system then creates application runtime bundles, such as EASMs, and maps for the EAS to EASMs (element 504). EASs and EASMs may be mapped one to one, one to multiple, or multiple to one to associate the application software with a computer, policy, and resources.

Next, the EASMs are configured (element 506). Configuration of an EASM is further explained within the discussion of FIG. 7 below. In one embodiment, configuration of the EASM involves setting compilation flags, describing communications channels with resources and servers, describing runtime behavior of applications in the application archive files, and the like.

After the EASMs are configured, in one embodiment, the system repackages each EAR in the EAS from the runtime definitions; the repackaging is similar to exporting the EAR in many embodiments. The application software and configuration data may be bundled in the EAS with the policy information included (element 508). The new package is placed in the file system (element 510).

Turning to FIG. 6, there is shown an example of a flowchart 600 to create and manage a map of an application archive to runtime configuration data in an application bundle. The system selects an EAR from a group of EARs in the EAS (element 602). The system may address EARs in any order.

After selecting an EAR, the system selects the J2EE module from the EAR (element 604). In one embodiment, the J2EE module includes deployment descriptors such as an identified deployment target. Next, the deployment target information is extracted from the module (element 606).

After extracting the deployment target information from the module, the system evaluates whether or not an EASM with the same deployment target name exists. If an EASM with the same deployment target name does not exist (element 608), then one is created for it (element 610). In many embodiments, this evaluation is not affected by whether the deployment target is a local or remote development.

The module is added to the EASM maps (element 612). If there are more modules in the EAR (element 614), the process continues with selecting the J2EE module (element 604). In this embodiment, an EASM may be created per module in an EAR.

If the system determines that no more modules exist in the EAR, the system tests for another EAR. If another EAR is included in the EAS (element 616), then the process selects the next EAR (element 602). If there are no more EARs (element 616), the process continues in FIG. 7 with the EASM configuration.

Turning to FIG. 7, there is shown an example of a flowchart 700 to configure a deployment target based upon runtime configuration data in an application bundle. Flowchart 700 begins by selecting an application runtime bundle such as an EASM file from the application bundle, e.g., an EAS (element 702). Next, flowchart 700 locates deployment target based on the EASM (element 704).

After the system selects an EASM and a deployment target, the system evaluates whether non-EAS application binaries are deployed on the deployment target (element 706). If non-EAS application binaries are deployed on the deployment target, the process is flagged “sharable” (element 708). In one embodiment, if the EASM is denoted as “sharable”, ‘Process Sharable’, or the like, the system will search for a deployment target upon import with the server data indicated in the EASM. If the system finds a matching deployment target, the system configures any resources for the deployment target and deploys the EASM's mapped binaries onto the deployment target. If the system does not find a matching deployment target, a new deployment target will be created instead.

In another embodiment, non-EAS application binaries are not deployed on the deployment target and the process is flagged “non-sharable” (element 710). In one embodiment, a “non-sharable” deployment target may be pre-defined virtual disk. Thus, in further embodiments, if an EASM is denoted “non-sharable”, ‘Process Unsharable’, or the like, then the system creates a new deployment target on which to import the EASM.

If the deployment target type is the same as the cluster type (element 712), the EASM is marked as “cluster” (element 714). Clusters may represent a grouping of similar services to facilitate load balancing as well as provide high availability.

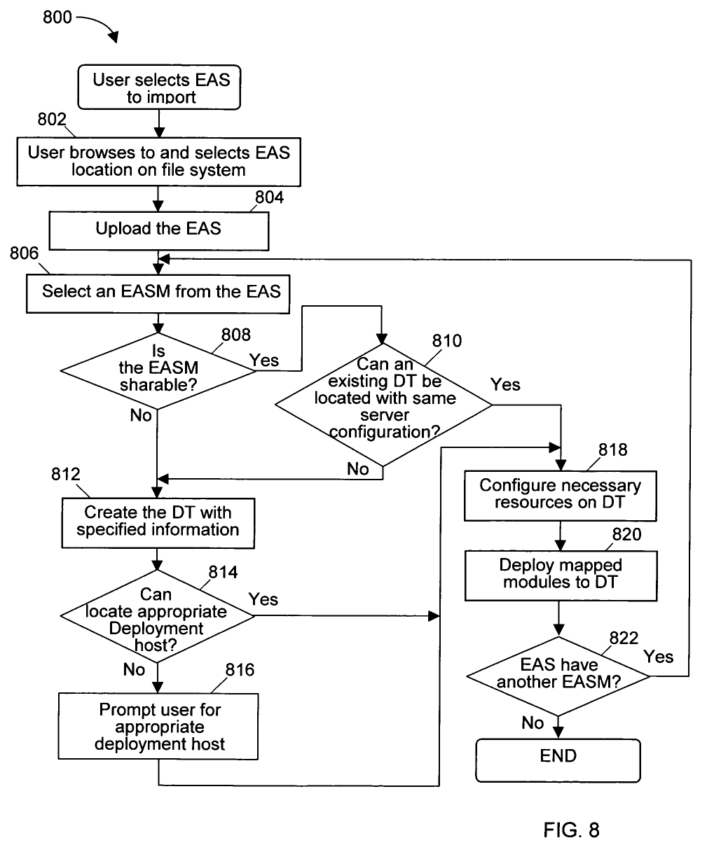

If the deployment target type of an application server is the same server type (element 716), the EASM is marked as “application server” (element 718). All other possibilities are unsupported in the present embodiment. Following this action, deployment specific information is gathered (element 720) such as deployment target properties, server data, resources, node and node group information, “Hints”, and security information. If there is another EASM (element 722), the process starts all over with selecting an EASM (element 702), otherwise the EAR bundling will continue with FIG. 8.

FIG. 8 depicts an example of a flowchart 800 to import an application bundle into a virtual deployment target. First, a user selects an application to be imported. Then, in element 802, the user selects a location on the file system for an application bundle to be imported. In the present embodiment, the application bundle is an Enterprise Archive Solution (EAS).

In element 804, the EAS is uploaded and the system selects an EASM from the EAS (element 806). In one embodiment, the EASM may contain similar formatting styles of server information, resources, and possibly other runtime configuration data.

If the EASM designates the deployment target as not sharable (element 808), importing the EASM triggers the system to create the deployment target. Thus, the system creates the deployment target with the specified information (element 812). In an alternate embodiment, the EASM is denoted as ‘Process Sharable’. Upon import, WebSphere™, analyzes a deployment target for the same server data. If WebSphere™, finds the described deployment target, WebSphere™, configures resources and deploys the EASM's mapped binaries onto the located deployment target. If WebSphere™, cannot locate an appropriate deployment host for the application software (element 814), WebSphere™, prompts the user for an appropriate deployment host and a new deployment target is created (element 816).

If the system locates an appropriate deployment host (element 814) based upon the runtime configuration data in the EASM, the system configures resources on the deployment target (element 818) and then deploys mapped application runtime bundles to the deployment target (element 820). If the EAS has another EASM (element 822), then the process returns to selecting an EASM as in element 806.

One embodiment of the invention is implemented as a program product for use with, e.g., system 100 shown in FIG. 1. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, indicate embodiments of the present invention.

In general, the routines executed to implement the embodiments of the invention, may be part of an operating system or a specific application, component, program, module, object, or sequence of instructions. The computer program of the present invention typically includes of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods and arrangements for deploying an application software including more than one applications to implement, e.g., a business solution on a virtual deployment target. It is understood that the form of the invention shown and described in the detailed description and the drawings are to be taken merely as examples. It is intended that the following claims be interpreted broadly to embrace all the variations of the example embodiments disclosed.

1. A method to deploy an application software embodied by one or more applications on a deployment target, comprising:
receiving an application bundle, the application bundle having the one or more applications, runtime configuration data, and mappings, the mappings being adapted to associate the runtime configuration data with the one or more applications;
determining the deployment target based upon the runtime configuration data;
installing the deployment target on a deployment host based upon the runtime configuration data; and
deploying the one or more applications onto the deployment target based upon the mappings.

2. The method of claim 1, further comprising:
receiving an instruction to deploy the application software and
associating the application software with the application bundle.

3. The method of claim 1, further comprising creating an application runtime bundle with the mappings to associate the one or more applications with the runtime configuration data.

4. The method of claim 3, wherein creating the application runtime bundle comprises creating an Enterprise Application Solution Module (EASM).

5. The method of claim 1, wherein receiving comprises receiving an Enterprise Archive Solution (EAS) having one or more Enterprise Archive Solution Modules (EASMs), one or more Enterprise Archive (EAR) files, and the mappings to associate the one or more EAR files with the one or more EASMs.

6. The method of claim 1, wherein determining the deployment target comprises creating the deployment target based upon the runtime configuration data.

7. The method of claim 6, wherein creating the deployment target comprises creating links between an environment and resources described by the runtime configuration data.

8. The method of claim 7, wherein installing the deployment target comprises associating the environment with a deployment host, wherein the deployment host is selected based upon the runtime configuration data associated with the deployment target.

9. The method of claim 1, wherein deploying comprises:
importing the one or more applications into the deployment target,
configuring the deployment target based upon application configuration data associated with the one or more applications; and
installing the one or more applications on the deployment target.

10. The method of claim 8, wherein configuring the deployment target comprises configuring the deployment target based upon a default application configuration.

11. The method of claim 8, wherein configuring the deployment target comprises copying the application configuration data from another deployment target.

12. The method of claim 1, wherein deploying comprises
selecting the runtime configuration data from multiple application runtime bundles associated with the application bundle;
locating the deployment target based upon descriptions of the deployment target in the runtime configuration data; and
determining whether the one or more applications are deployed on the deployment target.

13. An apparatus to deploy an application software embodied by one or more applications on a deployment target, comprising:
an interspection module to receive an application bundle, the application bundle having one or more applications, runtime configuration data, and mappings; to create the deployment target based upon the runtime configuration data; and to install the deployment target on a deployment host based upon the runtime configuration data; and
an exporter coupled with the interspection module to deploy the one or more applications onto the deployment target based upon the mappings.

14. The apparatus of claim 16, further comprising an applications installer coupled with the exporter to configure the deployment target based upon application configuration data associated with the one or more applications; and install the one or more applications on the deployment target, wherein the applications installer is installed on the deployment target.

15. The apparatus of claim 13, further comprising a bundle creator coupled with the interspection module to create an application runtime bundle with the mappings to associate the one or more applications with the runtime configuration data.

16. The apparatus of claim 13, wherein the interspection module receives an application bundle wherein the application bundle is an Enterprise Archive Solution (EAS) having one or more Enterprise Archive Solution Modules (EASMs), one or more Enterprise Archive (EAR) files, and the mappings to associate the one or more EAR files with the one or more EASMs.

17. The apparatus of claim 13, wherein the interspection module is adapted to create the deployment target by linking an environment with resources described by the runtime configuration data.

18. The apparatus of claim 17, wherein the interspection module is adapted to associate the environment with a deployment host, wherein the deployment host is selected based upon the runtime configuration data associated with the deployment target.

19. A machine-accessible medium containing instructions, which when executed by a machine, cause said machine to perform operations, comprising:
receiving an application bundle, the application bundle having an application software comprised of one or more applications, runtime configuration data, and mappings;
creating a deployment target based upon the runtime configuration data;
installing the deployment target on a deployment host based upon the runtime configuration data; and
deploying the one or more applications onto the deployment target based upon the mappings.

20. The machine-accessible medium of claim 19, wherein the operations further comprise:
receiving an instruction to deploy the application software and
associating the application software with the application bundle.

21. The machine-accessible medium of claim 19, further comprising creating an application runtime bundle with the mappings to associate the one or more applications with the runtime configuration data.

22. The machine-accessible medium of claim 21, wherein creating the application runtime bundle comprises creating an Enterprise Application Solution Module (EASM).

23. The machine-accessible medium of claim 19, wherein receiving comprises receiving an Enterprise Archive Solution (EAS) having one or more Enterprise Archive Solution Modules (EASMs), one or more Enterprise Archive (EAR) files, and the mappings to associate the one or more EAR files with the one or more EASMs.

24. The machine-accessible medium of claim 19, wherein determining the deployment target comprises creating the deployment target by creating links between an environment and resources described by the runtime configuration data.

25. The machine-accessible medium of claim 24, wherein installing the deployment target comprises associating the environment with a deployment host, wherein the deployment host is selected based upon the runtime configuration data associated with the deployment target.

26. An application bundle to deploy an application software embodied by one or more applications on a deployment target, comprising:
one or more application archive files for installation on a deployment target to implement the application software, the application archive files having one or more applications; and
one or more application runtime bundles having runtime configuration data and mappings to deploy the application software onto the deployment target, the runtime configuration data describing runtime behavior of the one or more applications to describe the deployment target based upon the mappings, wherein the mappings associate the runtime bundles with the one or more application archive files.

27. The application bundle of claim 26, the application runtime bundles comprise server data to describe rules and policies associated with the deployment target and a deployment host upon which the deployment target is to be installed.

28. The application bundle of claim 26, wherein the application runtime bundles have one or more descriptions of resources.

29. The application bundle of claim 26, wherein the one or more arrangement files describe a deployment host and node group of a cluster in the deployment target to facilitate configuration of the application software on the deployment target.
